(19) United States
(12) Patent Application Publication
(10) Pub. No.: US 2007/0168234 A1
(43) Pub. Date: Jul. 19, 2007

(54) Efficient system and method for obtaining preferred rates for provision of health care services

(75) Inventors: Karen Rutkowski, Glastonbury, CT (US); Todd David Pline, Milford, CT (US); Vincent Yee Hwa Sai, West Hartford, CT (US); Christine Skelly, West Hartford, CT (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Aetna, Inc., Hartford, CT (US)

(21) Appl. No.: 11/334,865

(22) Filed: Jan. 19, 2006

(51) Int. Cl. G06Q 40/00

(52) U.S. Cl. 705/4

(57) ABSTRACT

Techniques are disclosed for allowing a heath care provider to receive payment from a customer's pre-funded account in exchange for health services provided to a customer, through the use of a healthcare card. The card is issued to the customer by a health plan organization and is linked to a pre-funded account for that customer. The health care provider is under contract with the organization to offer a pre-determined fee structure for covered services. Customers can obtain contracted rates for services via the card, regardless of any limitations that might apply under a health insurance policy or other program. Online, real-time methods are disclosed for the substantiation of payment claims to ensure they are within governmental guidelines for FSA/HRA/HSA coverage. Additional aspects are disclosed whereby health care providers can choose to be paid directly from a health plan organization via an electronic funds transfer into the provider's bank account.

### FIELD OF THE INVENTION

This invention relates generally to the field of health insurance and more specifically to the area of account-based coverage and claim substantiation.

### BACKGROUND OF THE INVENTION

In recent years, health insurance has become a topic of increasing conversation and debate. The basic principles of health insurance have remained the same—a person subscribes to a health insurance policy, often through his employer, and pays the insurance company a premium in exchange for coverage under the policy's terms. In addition to receiving some type of guarantee that their healthcare services will be paid for, subscribers additionally typically receive the benefit of a lower price for those services, as participating health care providers generally are under contract with the insurance company to limit the maximum amount the insurance company will pay the provider for particular services rendered. However, payment systems within the healthcare industry have been notoriously complicated. A typical subscriber to an insurance policy may have no idea of the final price he will pay for services until weeks after those services have actually been provided.

Although the basic principles may not have changed, increasing costs of health care have created opportunities for many variations and nuances beyond the basic principles in order to more adequately serve the needs of health insurance customers. These variations include, for example, types of plans (POS, PPO, HMO, etc.), deductible limits, co-payment amounts, coinsurance rates, specific benefit limits, in-network discounts, etc. The federal government has also recently created several methods by which consumers can reduce the amount of their health care expenditures. For example, a flexible spending arrangement (FSA) allows employees and/or their employers to contribute up to a fixed amount of pre-tax dollars annually that may be used to pay various types of health care expenses. The annual contribution is “use-it or lose-it”, and thus any remaining funds in the FSA are not carried over to the next fiscal year. More recently, the federal government created the “Health Reimbursement Arrangement” (HRA). The HRA is similar to the FSA, but is funded solely by an employer and funds can carry-over from year to year. Another new vehicle is the “Health Savings Account” (HSA), which can be funded with or without employer involvement by anyone with a high deductible health plan (HDHP). Funds in an HSA may earn interest that accrues tax-free.

HRAs, HSAs and FSAs are not insurance products. A consumer with an HRA, HSA or FSA typically makes a health care purchase or pays a health care provider as usual—within or outside the context of any health insurance coverage he may have—and then submits a receipt to the HRA or FSA administrator for reimbursement. However, HRAs, HSAs and FSAs may only be used for “qualified” expenses, according to guidelines of the Internal Revenue Service. For this reason, a claim for payment under an HRA, HSA or FSA must be substantiated in order to verify that the expense was indeed qualified. This reimbursement and substantiation process can be labor-intensive and time-consuming, and ultimately can delay reimbursement to the consumer. To address this situation, some HSA, FSA and HRA administrators have begun to issue credit/debit cards that can be used by consumers to access funds in their HSA, FSA and HRA accounts at points-of-sale. Although these credit/debit cards may remove the need for the consumer to submit forms for purposes of reimbursement (since no money has yet come out of the consumer's pocket for the transaction), they do not adequately address the substantiation issue, and thus consumers using these cards still may need to submit paperwork for substantiation (since it may not be clear that the payment was for qualified expenses).

Some limited types of transactions, (for example, co-payments at healthcare offices or pharmacy charges), have been allowed to be automatically, or instantly, substantiated in prior systems. A more recent system allows auto-substantiation for purchased goods through the use of product's stock keeping unit (SKU). However, prior systems have not allowed for auto-substantiation at health provider offices for services provided in general.

Additionally, FSAs—and now HRAs—are not necessarily administered in conjunction with health insurance plans. Thus, although an employee without health insurance coverage could use his FSA, HSA or HRA to cover his expenses, he still may be unable to receive the benefit of any contracted rate his health care providers may have negotiated with an insurance company, and the overall cost for the services may therefore still be significantly higher than if he was insured and the services were covered. Furthermore, outside of the pharmacy context where PBM transactions have allowed for real-time lookup of insurance benefits, other healthcare service providers have been unable to obtain information such as contracted rates for a particular patient in real-time, and then apply those rates to a point-of-sale transaction.

### BRIEF SUMMARY OF THE INVENTION

Embodiments of the invention are used for allowing a heath care provider or merchant to receive payment from a customer's FSA, HRA, HSA or other type of pre-funded account in exchange for services or goods provided to a customer through the use of a healthcare card. The card is issued to the customer by or in conjunction with a health plan organization, such as a health insurance company, and is linked to an FSA/HRA/HSA account for that customer. The health plan organization need not be a health insurance company, however. The health care provider is under contract with the health plan organization to offer a predetermined fee structure for covered services provided. By using the healthcare card at the time of service, customers can obtain contracted rates regardless of any specific benefit limitations of their health insurance plan, and regardless of any medical necessity determination that might otherwise be required for coverage under a health insurance plan. Thus, unlike prior FSA/HRA/HSA payment systems, embodiments of the current invention allow any cardholder to obtain contracted rates for services, regardless of whether or not the cardholder is even a member of a health insurance plan

A further advantage of the present invention is that health care service providers can be guaranteed immediate payment of funds for services rendered to patients who use a fund-based healthcare card. The card is linked to an FSA/HRA/HSA or other pre-funded account for the patient. At the time services are provided, the provider can use the card to complete all aspects of the transaction, without any need for later processing or claim settlement. The card can be used to substantiate the service charges against applicable governmental rules.

Another advantage of the present invention is that substantiation of payment claims to ensure they are not outside the guidelines for FSA/HRA/HSA coverage can be accomplished online, in real time, and even prior to the provision of services. Prior FSA/HRA/HSA reimbursement or payment systems necessitated intensive manual processes and forms to accomplish this task.

Still another advantage found in embodiments of the present invention is health care providers can choose whether to be paid through a conventional credit/debit card network transaction, or directly from the health plan organization administering the FSA/HRA/HSA or other type of pre-funded account via an electronic funds transfer into the provider's bank account. Prior FSA/HRA/HSA reimbursement systems required the provider to use either a credit/debit card network or manually submit forms.

In one aspect of the invention, a system is provided for payment of expenses for healthcare services provided to a patient by a healthcare service provider, the system comprising a healthcare card provided to the patient and containing information corresponding to a healthcare expense account associated with the patient, a database system associated with a health plan organization and storing contracted fee schedules, the health plan organization being associated with the card and the account, and a computing device located at the healthcare service provider and in connection with the database system, the computing device for reading said healthcare card and for communicating with the database system to obtain the value of a contracted fee to be charged to the account in exchange for the services.

In another aspect of the invention, a method is provided for providing a preferential billing rate for a service to be performed on a patient by a healthcare service provider, the method comprising issuing a healthcare card to a patient, the card corresponding to the patient and to a healthcare expense account associated with the patient, receiving a request from the healthcare service provider, the request including information obtained from the card and an indication of the nature of the service to be provided to the patient, and notifying the healthcare service provider of the preferential billing rate for the service to be performed.

In still another aspect of the invention, a method is provided for substantiating a claim for a healthcare service provided or to be provided to a patient by a healthcare service provider, the method comprising receiving a request from the healthcare service provider, the request including information obtained from a healthcare card issued to the patient and an indication of the nature of the service provided or to be provided, verifying whether or not the service is qualified under applicable governmental rules, and if the service is not qualified, prompting the healthcare service provider to certify why the service should be considered qualified, wherein the healthcare card has been previously issued by a health plan organization and corresponds to the patient and to a healthcare expense account associated with the patient.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a general overview of networks and components used for processing FSA/HRA/HSA or other pre-funded account transactions with a health care card, as contemplated by an embodiment of the present invention;

FIG. 2 is a flowchart illustrating a method of using a FSA/HRA/HSA-linked health care card at a health service provider to allow real-time payment to the provider at a contracted rate, in accordance with an embodiment of the invention;

FIG. 3 is a flowchart illustrating a method of using a FSA/HRA/HSA-linked health care card at a health service provider to allow real-time substantiation of claims, in accordance with an embodiment of the invention; and

FIG. 4 is a diagram illustrating a healthcare card for linking with a FSA/HRA/HSA account, in accordance with an embodiment of the invention.

### DETAILED DESCRIPTION OF THE INVENTION

The following examples further illustrate the invention but, of course, should not be construed as in any way limiting its scope.

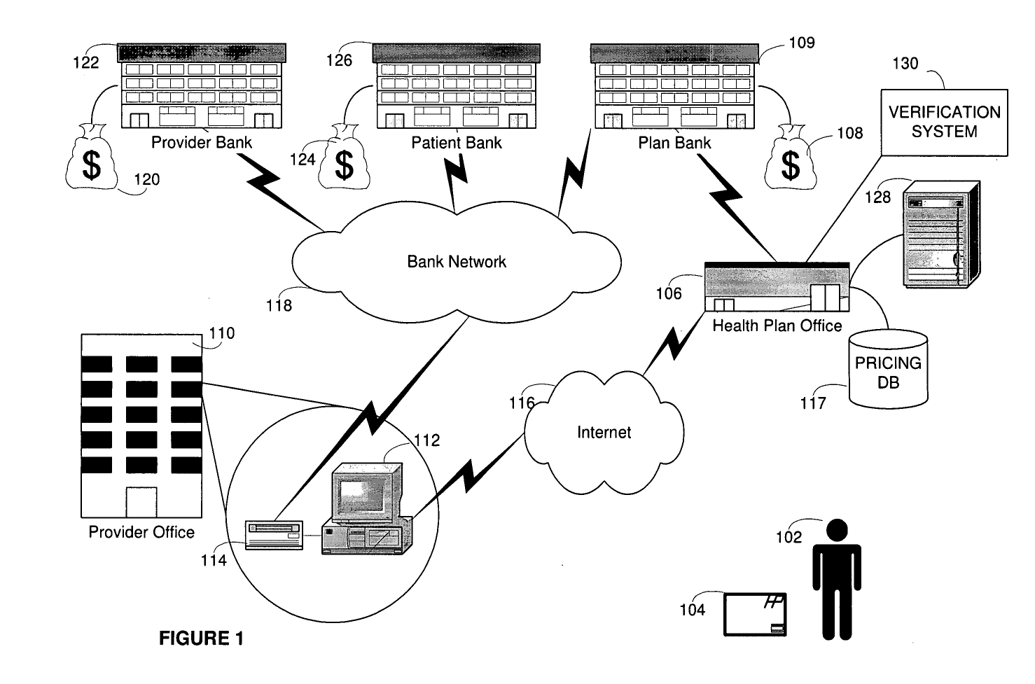

Turning to FIG. 1, an implementation of a system contemplated by an embodiment of the invention is shown with reference to an overall healthcare financial network environment. A patient 102 is issued a healthcare card 104 by a health plan organization 106. In one embodiment, the health plan organization 106 is a health insurance company. Alternatively, the health plan organization administers health coverage programs for a self-insured employer. The patient may or may not be covered under any insurance plan of the health plan organization 106. The card 104 contains indicia relating to the patient's 102 identity and to an account 108 held by the health plan or the plan's bank 109. Additionally, the card 104 may contain information relating to a particular health plan offered by the health plan organization 106. The account 108 is preferably associated with a health reimbursement arrangement (HRA) for the patient 102. Alternatively, the account 108 is associated with a flexible spending account (FSA) or a health savings account (HSA). Alternatively, the account 108 is associated with an account funded through employee post-tax payroll deductions. Alternatively, the account 108 is associated with an account funded directly by consumer contributions. Generally, healthcare providers contract with health plan organizations to receive a specified payment for services provided to individuals enrolled in a plan associated with that organization. As the patient's portion of financial responsibility grows, for example, through the use of plans with higher deductibles, the assurance of payment correspondingly becomes of increasing importance to the provider. Because a patient 102 need not be covered by an insurance policy in order to hold an HRA or FSA, an uninsured patient using a health care card 104 issued by the health plan organization 106 and linked to the patient's HRA or FSA or other type of pre-funded account 108, as used in some embodiments of the invention, may nevertheless receive healthcare services at the generally lower contracted prices. In another embodiment, the card 104 may have a predetermined stored value associated with it, allowing it to be purchased by anyone at a retail point of sale, such as a drug store or convenience store. In that embodiment, after purchasing the card, the purchaser would be able to use the card to obtain healthcare products or services at contract rates from participating providers, in an amount up to the value associated with the card. In other embodiments, the card is rechargeable or re-loadable. For example, the cardholder may add value to the card balance, either initially or after some or all of the original balance is depleted through use, by calling a customer service telephone number and purchasing additional value with a standard credit card. Value may be added as well by a cash or check transaction at a retail point of sale, using the point-of-sale terminal and banking network to add value to the account balance.

The patient 102, wishing to receive healthcare services from a provider, presents his card 104 at the provider office 110 at the time of service. At the provider office is a computer 112 and a card reader 114, which is preferably attached to the computer 112. The computer is connected to at least one network, such as the Internet 116, enabling communication with outside parties, including the health plan organization 106. Additionally, the card reader 114 and/or the computer 112 are capable of connecting to a bank transaction network 118, through which various financial institutions transmit and receive credit card and other financial transactions. Through the use of the bank transaction network 118, the healthcare provider 110 may receive payment for services rendered by having funds deposited into an account 120 held by a bank 122 or other institution. Additionally, in some embodiments of the invention, the patient 102 has an account 124 held by a bank 126 or other institution, which is similarly connected to the bank transaction network 118, and can be accessed to supplement any transaction for which there may otherwise be insufficient funds. The transfer of funds is preferably initiated or authorized by the health plan organization through a payment module of its system.

By receiving the patient's 102 card 104 at the provider office 110, the health care provider can use the computer 112 to communicate with the health plan organization 106 via the Internet 116 and obtain pertinent information, such as whether the patient 102 is eligible to receive health benefits under the terms of a health insurance policy or other program. Additionally, in some embodiments of the invention, the provider 110 can receive from the health plan organization 106, through the network 116, notification of the applicable contracted prices for the services to be provided to the patient 102, through the use of a database system 117. In some embodiments, the provider 110 submits procedure codes and or diagnosis codes in order to obtain said applicable prices.

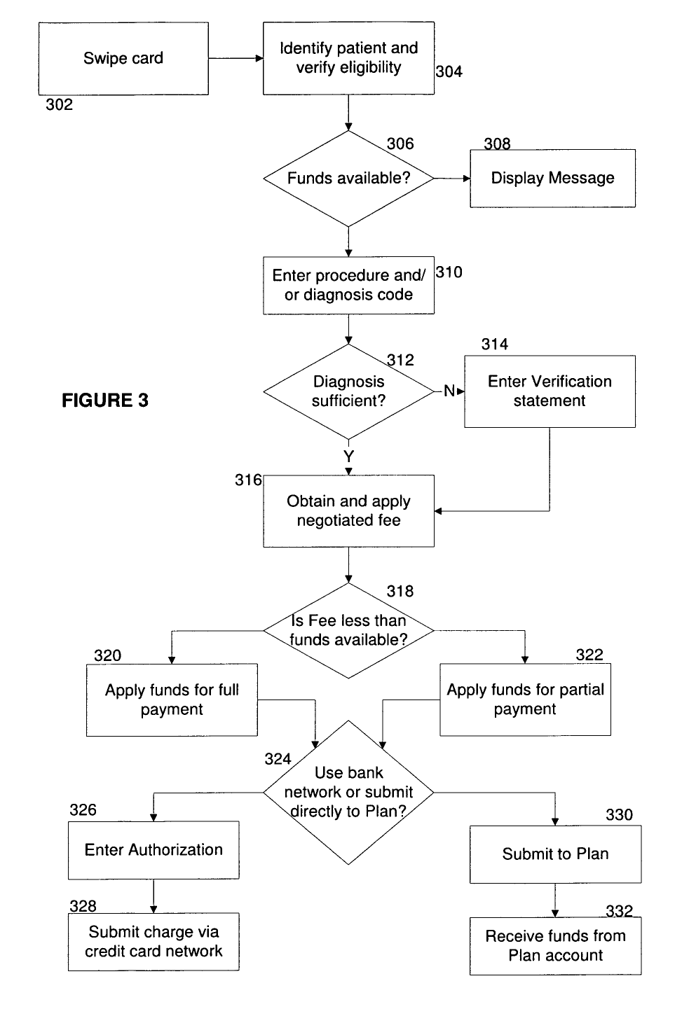

Upon provision of services, the provider 110 can swipe the card 104 via the card reader 114 and initiate a transaction for the services at the applicable prices. The transaction preferably takes the form of an ordinary credit card or debit card transaction, utilizing the bank transaction network 118 to facilitate transfer of funds. Upon successful processing of the transaction, the provider 110 receives a confirmation of the transaction or payment via the network 118. At this point, the provider 110 preferably sends information regarding the encounter (e.g., patient information, procedure code, diagnosis code, payment information, etc.) to the health plan organization 106, either electronically through a network such as the Internet 116 or in an off-line manner. The health plan organization 106 uses the information to match the encounter information to debit card transaction using its substantiation system 128 in order to substantiate that the services provided for the patient 102 were valid for coverage under the FSA, HRA or HSA 108 if necessary. In some embodiments, the substantiation procedure performed by the health plan organization 106 is performed automatically using electronic information submitted by the provider 110. In some embodiments, the substantiation process is performed in an online manner at the time services are provided to the patient 102, in accordance with, for example, procedures described below with respect to FIG. 3. In other embodiments, no substantiation is necessary.

Additionally, in some embodiments of the invention, back-end verification may be performed to ensure that any applicable contracted price was in fact applied for the transaction. Such verification may be performed, for example, on an aggregate level in order to compare a sum of those contracted prices provided to service providers to a corresponding sum of those prices actually charged to pre-funded accounts. This provides an additional level of protection to consumers. A verification system 130 located at the health plan organization 106 or elsewhere may perform these functions.

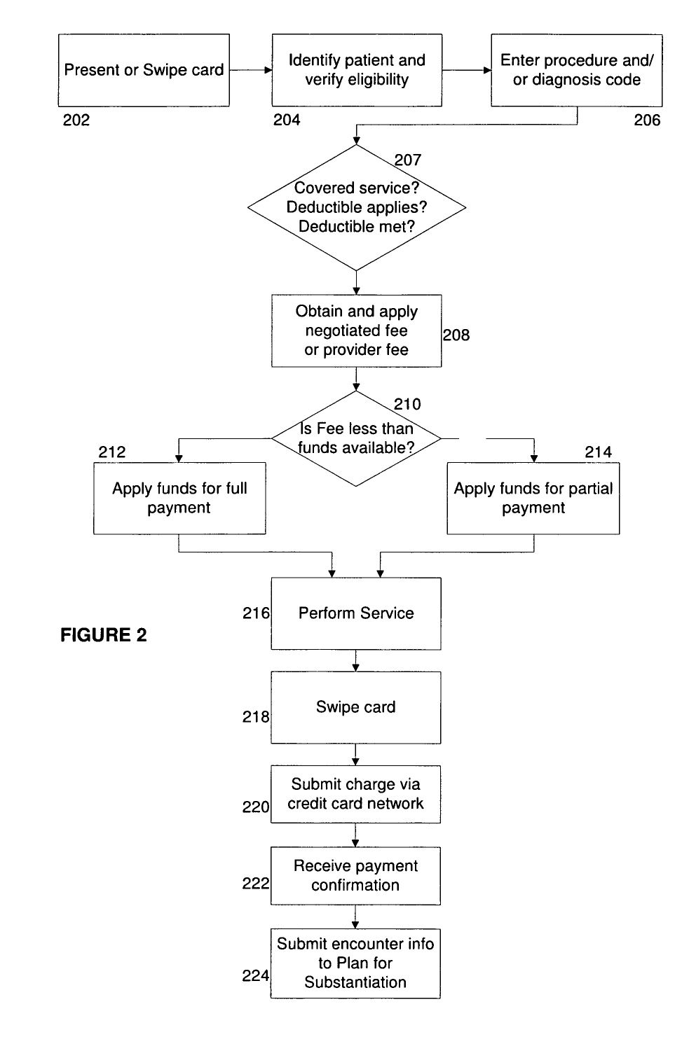

Turning to FIG. 2, a flowchart illustrates a method of using a FSA/HRA/HSA-linked health care card at a health service provider to allow real-time payment to the provider at a contracted rate. The card is presented or swiped at step 202 in order to enter patient and billing information into a computer. The computer, connected to the health plan organization via a network such as the Internet, submits the patient information to check his eligibility for coverage at step 204. If necessary, the health plan organization requests the provider to provide additional patient information. The provider uses the computer to enter information regarding the services to be provided, such as a procedure code and diagnosis code, at step 206, and submits this information to the health plan organization. In some embodiments, a diagnosis code is only entered for those services for which there is some possibility of a non-allowed status (e.g., a potentially cosmetic procedure). Alternatively, the diagnostic code is required for all charges to provide a more complete member data record. In response to the data entry, it is determined at step 207 whether or not the service is covered under a contracted fee schedule, and whether or not funds must be paid by the patient from a deductible. If the service is covered, then at step 208 the provider receives the applicable fee to charge the patient for the service, in accordance with a previously negotiated agreement between the provider and the health plan organization. In some embodiments of the invention, the fee schedule for a particular provider can depend on the location where the services are provided (e.g., in the provider's office or in a hospital), so information regarding the site of service is preferably submitted in addition to or accompanying other information. If the service is not covered, the provider may charge the patient an appropriate fee. If the service is subject to a deductible, the applicable fee is preferably reduced by the extent to which the patient's deductible has already been met. The contracted fee is preferably the same regardless of whether or not the patient has coverage under a health insurance policy. Using the billing information provided by the card, the computer inquires at step 210 whether there are sufficient funds available in the patient's linked FSA/HRA/HSA account to cover the applicable fee. If so, a transaction is set up to fully fund the fee from the linked account at step 212. If not, a transaction is set up at step 214 to partially fund the fee from the linked account, with the remainder to be paid via other means. After the health services are performed at step 216, in some embodiments of the invention the card is swiped again at step 218 to initiate a charge against the linked account. The charge is submitted at step 220 and the provider receives confirmation of payment at step 222. At this point, information regarding the encounter is sent either via the computer or through conventional means to the health plan organization at step 224, in order that it can be substantiated as valid under the FSA/HRA/HSA guidelines if necessary.

In some embodiments of the invention, the substantiation process is performed automatically, in real-time and prior to the submission of any charge for the health services performed. The ultimate level of auto-substantiation in embodiments of the invention is comparable to that of a manual process, relying on diagnosis of an illness or injury or, in the absence of an applicable diagnosis, certification as to the purpose of the treatment from the provider. The system preferably substantiates every encounter submitted, rather than using any statistical sampling.

An illustration of one such embodiment in described with respect to FIG. 3. A patient's healthcare card is presented or swiped at step 302 in order to enter patient and billing information into a computer. The computer, connected to the health plan organization via a network such as the Internet, submits the patient information to check his eligibility for coverage at step 304. If necessary, the health plan organization requests the provider to provide additional patient information. As an initial validation step, the computer inquires whether any funds are available in the linked FSA/HRA/HSA or other type of pre-funded account at step 306. If not, a message is preferably returned at step 308. Otherwise, the provider uses the computer to enter information regarding the services to be provided, such as a procedure code and diagnosis code, at step 310, and submits this information to the health plan organization. If necessary, the health plan organization substantiates the information at step 312 according to FSA/HRA/HSA guidelines to see if the diagnosis/procedure submitted for this patient is sufficient. In one embodiment, the information is substantiated by comparing one or both of the diagnosis and procedure code to a database of activities known to fall outside the FSA/HRA/HSA guidelines (e.g., purely cosmetic procedures). If the submitted information is insufficient, the provider is prompted via the computer to enter a verification statement at step 314 to certify that, for example, the health service is being provided to treat or prevent disease and is not for cosmetic or convenience purpose. At step 316, the provider receives the applicable fee to charge the patient for the service, in accordance with a previously negotiated agreement between the provider and the health plan organization. This contracted fee is preferably the same regardless of whether or not the patient has coverage under a health insurance policy or other program. Using the billing information provided by the card, the computer inquires at step 318 whether there are sufficient funds available in the patient's linked FSA/HRA/HSA or other type of pre-funded account to cover the applicable fee. If so, a transaction is set up to fully fund the fee from the linked account at step 320. If not, a transaction is set up at step 322 to partially fund the fee from the linked account, with the remainder to be paid via other means.

In some embodiments of the invention, the provider has an option at step 324 to either submit the charge via a debit/credit card network or directly to the health plan organization (via, for example, the Internet). If a debit/credit card network is to be used, then the provider is given an authorization code from the health plan organization at step 326. The authorization code verifies that the charge has been substantiated and allows the charge to be linked to the plan's substantiation file. The charge is submitted at step 328 and funds are held against the FSA/HRA/HSA or other type of pre-funded account to assure payment of the charge. If the provider submits the charge directly to the health plan organization at step 330, then the health plan organization causes payment to be made directly to the bank account of the provider's office, which receives the funds at step 332. The provider in this way receives immediate or near-immediate payment for the services rendered.

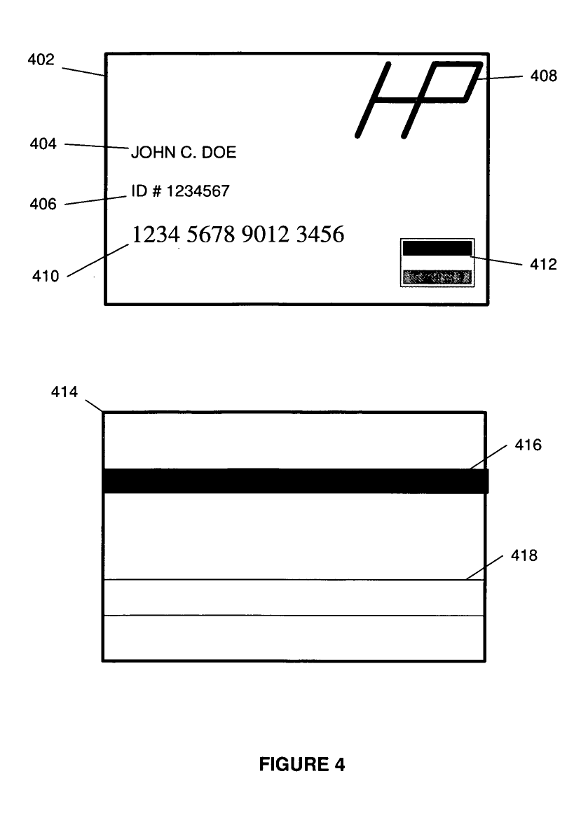

Turning to FIG. 4, and exemplary healthcare card with credit/debit feature is shown, in accordance with an embodiment of the invention. The card is linked to an FSA, HRA or HSA account corresponding to the cardholder and is issued by a health plan provider. On the face 402 of the card, information is printed regarding the identity of the cardholder, including the cardholder's name 404 and identification number 406. The face 402 of the card also contains a logo 408 or name of the health plan provider, a sixteen-digit account number 410 for use in credit/debit card transactions, and the name or logo 412 of the network on which the credit/debit transactions should be processed (e.g., MasterCard, Visa, Discover, etc.) On the back of the card 414 is a magnetic strip 416 containing account and/or patient indicia suitable for reading with a magnetic card reader. The card 414 may also contain a signature field 418 on the back of the card 414 on which the cardholder may sign. Additionally or alternatively, the card can be equipped with a RFID chip or similar device to allow for reading and/or writing information from/to the card based on proximity of the card to a read/write device.

In addition to FSAs, HRAs and HSAs, a healthcare card such as the one described above is used to link to additional types of accounts in some embodiments of the invention. For example, a card can link to an employee's account that is funded through payroll deductions (post-tax) by his employer. Such an arrangement can allow employees to budget their health care dollars on a monthly basis, and allows access to preferential contracted rates of service providers. Either the employee or employer can pay any monthly fee charged by the card administrator. Alternatively, a card can link to a “virtual” or notional account that may not contain actual funds, but instead represents, for example, an unsecured commitment by an employer to pay for applicable healthcare services charged to an employee's healthcare card. Alternatively, a card can link to an account established and funded directly by a consumer, not through his employer.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for payment of expenses for healthcare services provided to a patient by a healthcare service provider, the system comprising:
a healthcare card provided to the patient and containing information corresponding to a healthcare expense account associated with the patient;
a database system associated with a health plan organization and storing contracted fee schedules, the health plan organization being associated with the card and the account; and
a computing device located at the healthcare service provider and in connection with the database system, the computing device for reading said healthcare card and for communicating with the database system to obtain the value of a contracted fee to be charged to the account in exchange for the services.

2. The system of claim 1 wherein the account is associated with a health reimbursement arrangement (HRA) or a flexible spending arrangement (FSA).

3. The system of claim 1 wherein the account is associated with a health savings account (HSA).

4. The system of claim 1 wherein the account is pre-funded.

5. The system of claim 4 wherein the account is pre-funded by the patient.

6. The system of claim 1 wherein the account is funded through payroll deductions by the patient's employer.

7. The system of claim 1 wherein the account is an unsecured commitment by the patient's employer.

8. The system of claim 1 further comprising a payment module associated with the health plan organization for causing funds to be transferred into a bank account of the healthcare service provider at the time the services are provided to the patient according to the contracted fee.

9. The system of claim 8 wherein the funds are transferred from the account associated with the patient.

10. The system of claim 1 further comprising a fee verification system for verifying that the contracted fee was charged for the provided services.

11. The system of claim 1 wherein the healthcare card is a debit card and/or credit card and is used to authorize funds to be transferred to the healthcare service provider over a standard credit card network.

12. The system of claim 1 further comprising a substantiation system associated with the health plan organization for substantiating that expenses are qualified under applicable governmental rules.

13. A method for providing a preferential billing rate for a service to be performed on a patient by a healthcare service provider, the method comprising:
issuing a healthcare card to a patient, the card corresponding to the patient and to a healthcare expense account associated with the patient;
receiving a request from the healthcare service provider, the request including information obtained from the card and an indication of the nature of the service to be provided to the patient; and
notifying the healthcare service provider of the preferential billing rate for the service to be performed.

14. The method of claim 13 further comprising:
causing the transfer of funds, corresponding to the provision of the service, to a bank account associated with the healthcare service provider and according to the preferential billing rate.

15. The method of claim 14 wherein the funds are transferred from the healthcare expense account associated with the patient.

16. The method of claim 13 further comprising:
substantiating the information in the request to verify that the service is qualified under applicable governmental rules.

17. The method of claim 16 wherein substantiating the information comprises:
comparing information included in the request regarding the nature of the service to be provided to the patient against a database of activities previously known to be unqualified under the applicable governmental rules.

18. The method of claim 13 wherein the pre-funded account is associated with a health reimbursement arrangement (HRA) or a flexible spending arrangement (FSA).

19. The method of claim 13 wherein the healthcare expense account is an unsecured commitment by the patient's employer.

20. The method of claim 13 wherein the healthcare expense account is pre-funded by the patient.

21. The method of claim 13 wherein the healthcare expense account is funded through payroll deductions by the patient's employer.

22. The method of claim 13 wherein the patient is not a holder of any health insurance policy.

23. A method for substantiating a claim for a healthcare service provided or to be provided to a patient by a healthcare service provider, the method comprising:
receiving a request from the healthcare service provider, the request including:
information obtained from a healthcare card issued to the patient; and
an indication of the nature of the service provided or to be provided;
verifying whether or not the service is qualified under applicable governmental rules; and
if the service is not qualified, prompting the healthcare service provider to certify why the service should be considered qualified;
wherein the healthcare card has been previously issued by a health plan organization and corresponds to the patient and to a healthcare expense account associated with the patient.

24. The method of claim 23 further comprising:
transferring funds, corresponding to the provision of services, to a bank account associated with the healthcare service provider.

25. The method of claim 24 wherein the funds are transferred from the healthcare expense account associated with the patient.

26. The method of claim 23 wherein the healthcare expense account is an HRA or FSA.

27. The method of claim 23 wherein verifying whether or not the service is qualified comprises:
comparing the indication of the nature of the service from the request against a database of activities previously known to be unqualified under the applicable governmental rules.
